(19) United States
(12) Patent Application Publication
(10) Pub. No.: US 2010/0235479 A1
(43) Pub. Date: Sep. 16, 2010

(54) DEVICE AND METHOD FOR IDENTIFYING ENTITIES TO BE UPGRADED, ADDED OR REMOVED

(75) Inventor: Maria Toeroe, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 12/402,234

(22) Filed: Mar. 11, 2009

(51) Int. Cl. G06F 15/177

(52) U.S. Cl. 709/221

(57) ABSTRACT

Node, computer software and method for identifying a target set of entities associated with a first configuration of a computer system that are to be modified for arriving at a second configuration of the computer system. The method includes selecting a single service, determining a characteristic of the single service, wherein the characteristic of the service is indicative of whether the single service is provided in both the first and second configurations, only in the first configuration or only in the second configuration, identifying, based on the selected service and its characteristic, one or two corresponding entity groups that are related to the single service, and mapping subsets of entities associated with the identified corresponding entity groups for transitioning the computer system from the first configuration to the second configuration.

### TECHNICAL FIELD

The present invention generally relates to systems, software and methods and, more particularly, to mechanisms and techniques for identifying one or more entities that need to be upgraded, added and/or removed for arriving at a new configuration.

### BACKGROUND

During the past years computer based services have evolved such that a high availability of these services is required. Achieving service continuity means maintaining customer data and session state without disruption across switchover or other fault-recovery scenarios. The systems providing these services are called high-availability systems (HA systems).

HA systems are systems that are implemented primarily for the purpose of improving the availability of services which the systems provide. Availability can be expressed as a percentage of time during which a system or service is “up.” For example, a system designed for 99.999% availability (so called “five nines” availability) refers to a system or service which has a downtime of only about 0.44 minutes/month or 5.26 minutes/year.

HA systems provide for a designed level of availability by employing redundant nodes, which are used to provide the high availability services when various events are taking place, for example, system components fail, software upgrades are performed, etc. For example, if a server running a particular application crashes, an HA system will detect the crash and fail-over the application on another, redundant node. Various redundancy models can be used in HA systems. For example, an N+1 redundancy model provides a single extra node (associated with a number of primary nodes) that is brought online to take over the role of a node which has failed. However, in situations where a single HA system is managing many services, a single dedicated node for handling failures may not provide sufficient redundancy. In such situations, an N+M redundancy model, for example, can be used wherein more than one (M) standby nodes are included and available.

As HA systems become more commonplace for the support of important services such as file sharing, internet customer portals, databases and the like, it has become desirable to provide standardized models and methodologies for the design of such systems. For example, the Service Availability Forum (SAF) has standardized application interface services (AIS) to aid in the development of portable, highly available applications. As shown in the conceptual architecture stack of FIG. 1, the AIS 10 is intended to provide a standardized interface between the HA applications 14 and the HA middleware 16, thereby making them independent of one another. Each set of AIS functionality may be associated with an operating system 20 and a hardware platform 22.

The SA Forum specifications enable the implementation of carrier grade systems and services built with commercial off-the-shelf building blocks. This modular architecture, built on open standard hardware and software, allows for greater reuse and a much quicker turnaround for new product introductions. The reader interested in more information relating to the SAF is referred to www.saforum.org.

An example of a HA system that may undergo an upgrade from configuration A to configuration B is shown in FIG. 2. FIG. 2 shows a cluster 100 having a current configuration A. The same HA system 100 is desired to be upgraded to configuration B. An Availability Management Framework (AMF), which is a software entity defined within the AIS specification, provides availability support for a single logical cluster that consists of a number of cluster nodes and components as shown in FIG. 2. For example, the cluster 100 having the current configuration A includes its own AMF 24, two AMF nodes 26, 28 and four AMF components 30-36. If cluster 100 is upgraded from configuration A to configuration B, the cluster 100 may have the components shown in FIG. 2 under configuration B. Under the new configuration B, cluster 100 may have AMF 38, two AMF nodes 40, 42 and four AMF components 44-50. The components 30-36 and 44-50 each represent a set of hardware and software resources that are being managed by the AMFs 24 and 38, respectively. In a physical sense, components are realized as processes of an HA application. The nodes 26, 28, 40, 42 each represent a logical entity which corresponds to a physical node on which respective processes managed as AMF components are being run, as well as the redundancy elements allocated to managing those nodes' availability.

This example indicates that the names of the objects of a cluster having potential configurations A and B may or may not be different if the upgrade is performed. Thus, it is difficult to identify those objects in cluster 100 having configuration A that need to be transformed to corresponding objects in cluster 100 having configuration B. The term transformed is understood herein to include at least one of (i) upgrading objects (entities for example) of the cluster having configuration A to arrive at a cluster having configuration B, (ii) removing objects of the cluster having configuration A such that corresponding objects in the cluster having configuration B are not present, and/or (iii) adding new objects in the cluster having configuration B that were not present in the cluster having configuration A.

Thus, whenever a new configuration is generated for an HA system, a migration path from the current configuration to the new configuration need to be determined. Thus, the migration path may be determined prior to upgrading the HA system to the new configuration, i.e., the new configuration is created, the migration path is determined and then the cluster is upgraded, based on the generated migration path, to the desired new configuration. The process of migration itself is called in SAF terms an upgrade campaign. To determine the upgrade campaign, an upgrade target has to be identified. The upgrade target may be a set of entities in the current configuration that need to be upgraded or manipulated in different ways to achieve the desired new configuration. Depending on the method used to create this new desired configuration, identifying the upgrade target is challenging for at least the reasons discussed next.

A traditional way of setting a desired new configuration is discussed next. Such new configuration may be set by acting on the current configuration according to well defined upgrade procedures. For example, if a set of entities can be upgraded to new software using a particular procedure, then this set of entities become part of the upgrade target set, as their software will be replaced when the procedure is executed.

One advantage of this method is that if the resulting configuration can be successfully validated, it comes with an already defined migration path, which is the sequence of upgrade procedures according to which the current configuration was manipulated to reach the new configuration. These upgrade procedures can be applied to the real system as the upgrade campaign.

A disadvantage of the traditional method is that these procedures will not change the number or the arrangement of the target entities, for example, their redundancy in the new configuration, regardless of whether it would be appropriate or even required for the new software. This is true because these well defined procedures were designed only to replace/upgrade the current software. As a result, the new configuration inherits many characteristics of the original configuration. This may also result in that new capabilities of the upgraded software are not used at all or not used efficiently in the new configuration as they were not part of/taken into account for the original configuration. The conventional method also makes it difficult to consider all the necessary changes to satisfy the different dependencies between entities as the entities may change with the change of the software. Therefore, it is a challenge to keep the configuration consistent.

An alternative way is to design the new configuration and the upgrade campaign “from scratch.” This implies providing a solution which is tailored according to the user requirements and the capabilities of the new software regardless of the current configuration. This alternative has the advantage that the new configuration is consistent and uses the new software capabilities. Further, this alternative has an advantage that it is not restricted and/or limited by assumptions or restrictions that had to be taken into account for the current configuration. However, a down side of this approach is that it is difficult to match the entities of the existing configuration to the entities of the new configuration particularly if the new configuration is automatically generated. One reason is that the entities from the current configuration cannot be related to corresponding entities in the new configuration based on their names because the names of the entities in the new configuration are also generated when the new configuration is generated and the new names may have no resemblance with the old names. In addition, when upgrading to the new configuration, some or all the attributes of the entities may change.

For performing a successful upgrade campaign, a pre-requisite is to identify the differences between the current configuration and the desired new configuration, i.e., to determine which entity from the current configuration should be transformed to which entity from the new configuration, which entity from the current configuration should be removed when performing the upgrade, and which entity should be added to the new configuration. The existing methods and mechanism are not capable of performing this identification when the new configuration is “from scratch.” For this reason, a new configuration “from scratch” is usually avoided in the existing HA systems as the services have to be provided continuously and removing old entities and replacing them with new ones is not possible as this approach creates an outage of the HA system.

Accordingly, it would be desirable to provide systems, computer software and methods that avoid the afore-described problems and drawbacks.

### SUMMARY

According to one exemplary embodiment, there is a method for identifying a target set of entities associated with a first configuration of a computer system that are to be modified for arriving at a second configuration of the computer system. The method includes selecting a single service; determining a characteristic of the single service, wherein the characteristic of the service is indicative of whether the single service is provided in both the first and second configurations, only in the first configuration or only in the second configuration; identifying, based on the selected service and its characteristic, one or two corresponding entity groups that are related to the single service; and mapping subsets of entities associated with the identified corresponding entity groups for transitioning the computer system from the first configuration to the second configuration.

According to another exemplary embodiment, there is a node configured to identify a target set of entities associated with a first configuration of a cluster that are to be modified for arriving at a second configuration of the cluster. The node includes a processor configured to select a single service; determine a characteristic of the single service, wherein the characteristic of the service is indicative of whether the single service is provided in both the first and second configurations, only in the first configuration or only in the second configuration; identify, based on the selected service and its characteristic, one or two corresponding entity groups that are related to the single service; and map subsets of entities associated with the identified corresponding entity groups for transitioning the computer system from the first configuration to the second configuration.

According to still another exemplary embodiment, there is a computer readable medium including computer executable instructions, wherein the instructions, when executed, implement a method for identifying a target set of entities associated with a first configuration of a computer system that are to be modified for arriving at a second configuration of the computer system. The method includes selecting a single service; determining a characteristic of the single service, wherein the characteristic of the service is indicative of whether the single service is provided in both the first and second configurations, only in the first configuration or only in the second configuration; identifying, based on the selected service and its characteristic, one or two corresponding entity groups that are related to the single service; and mapping subsets of entities associated with the identified corresponding entity groups for transitioning the computer system from the first configuration to the second configuration.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a software/hardware division of the HA system;

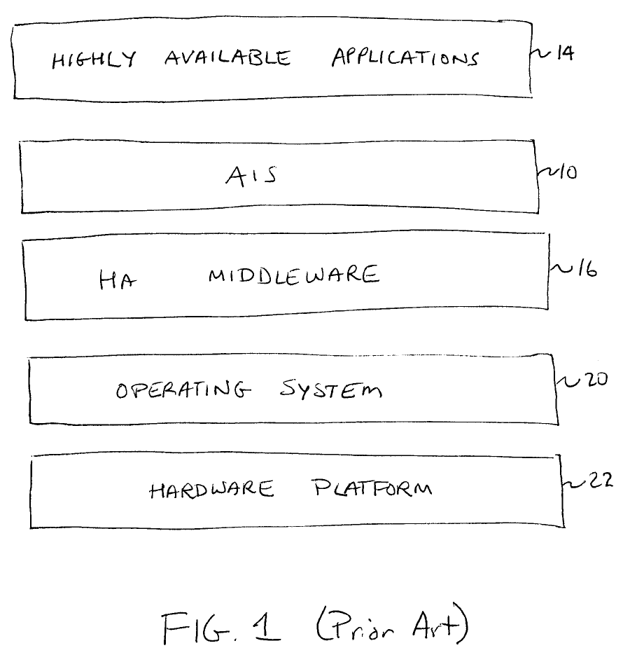

FIG. 2 is a schematic diagram of a current configuration and a desired new configuration of a HA system;

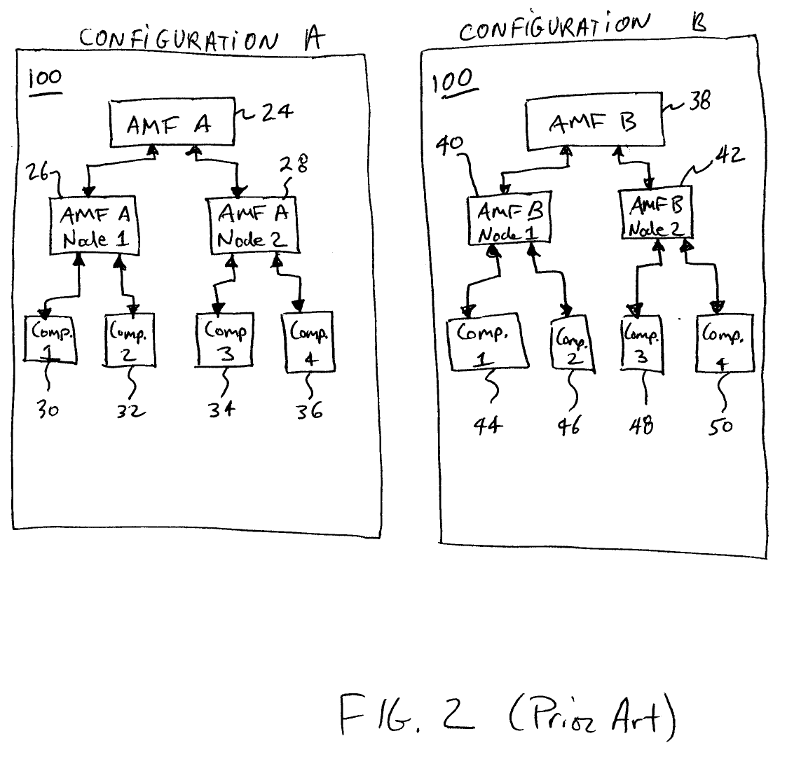

FIG. 3 is an illustration of a configuration upgrade of the HA system according to an elementary embodiment;

FIG. 4 is an illustration of various entities of current and new configurations of the HA system according to an exemplary embodiment;

FIG. 5 illustrates a succession of entities that are processed for mapping entity groups of the HA system according to an exemplary embodiment;

FIG. 6 is a flow chart illustrating steps for mapping entity groups of the HA system according to an exemplary embodiment; and

FIG. 7 is a schematic diagram of a computing system.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of HA systems. However, the embodiments to be discussed next are not limited to these systems but may be applied to other existing systems.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

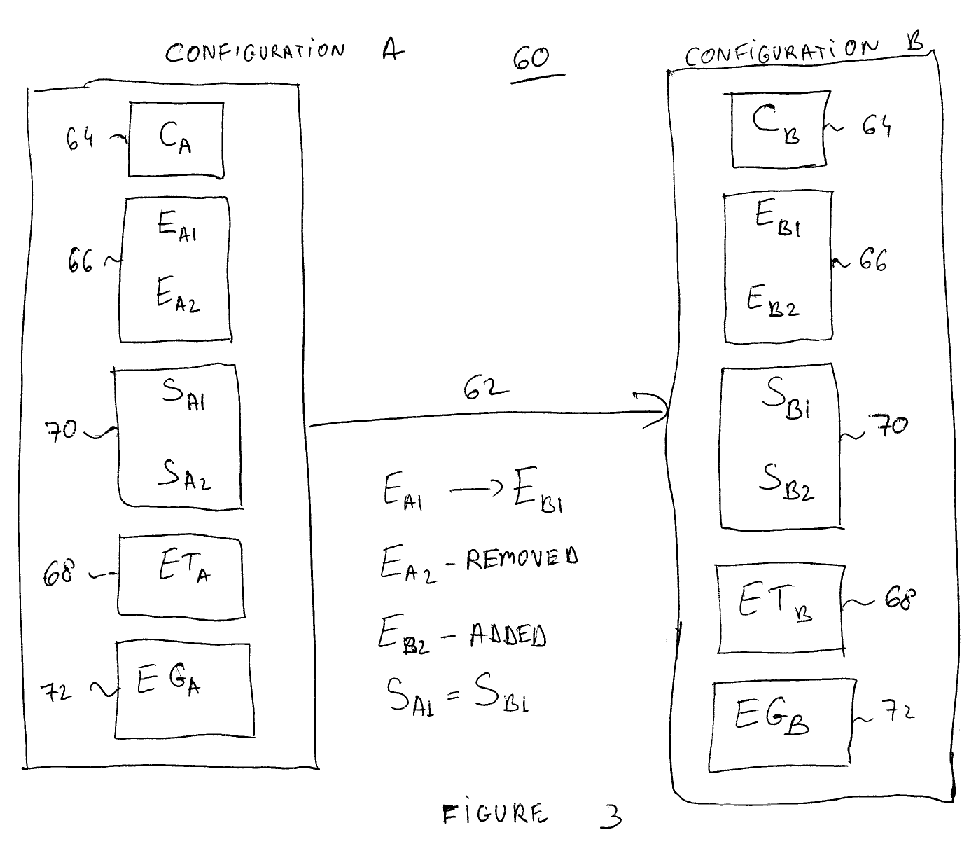

According to an exemplary embodiment illustrated in FIG. 3, a logical structure 60 of a current configuration A and a desired new configuration B of a same cluster is shown. This structure 60 indicates that during an upgrade campaign 62, one possible scenario is that a group of entities E_{A1} are upgraded to a corresponding group of entities E_{B1}, a group of entities E_{A2} are removed from configuration A and a group of entities E_{B2} are added in the new configuration B. It is noted that a group of entities or other objects is represented in the following by using a capital letter while the use of a small letter indicates a single element of the group.

Services provided by these entities are also affected by the upgrade 62. For example, according to this exemplary embodiment, services S_{A1} provided by entities E_{A1} in configuration A may be maintained in configuration B as new entities E_{B1} are providing services S_{A1}. However, in this embodiment, because entities E_{A2} are removed, associated services S_{A2} are not available in configuration B. In addition, because new entities E_{B2} are added in configuration B, new services S_{B2} are provided by new entities E_{B2}. According to other exemplary embodiments, all entities in the first configuration are upgraded to entities in the second configuration, or no entities are removed from the first configuration or no new entities are added to the second configuration or any other combination of the possibilities discussed above.

The logical structure 60 includes a cluster data element 64 that includes information about one or more nodes in the cluster. This information about the cluster may be formalized in terms of a set C={cᵢ|cᵢ is a node in the cluster, 0<i≦n, where n is the size of the cluster}. Thus, the cluster is included as C_{A} for configuration A and C_{B} for configuration B. C_{A} and C_{B} may be the same or different. For simplicity, it is considered in the following that C_{A} and C_{B} are identical. The structure 60 also includes entities data element 66. Element 66 includes various entities that might provide and/or protect the services. These entities may be represented by software, hardware or a combination of the two. Following the formalism introduced above, entities E are defined as E={eᵢ|eᵢ is a software entity in the cluster, 0<i≦p, where p is the number of different entities in the cluster}. In the example shown in FIG. 3, the entities in the first configuration are split into two groups of entities, i.e., group E_{A1} and group E_{A2} for indicating that the first group E_{A1} will be upgraded when performing the transition to configuration B while the second group E_{A2} will be removed. As discussed above, each of these groups may include plural entities. However, according to an exemplary embodiment, any of the groups may include only one entity or no entity.

Further, the structure 60 may include an entity type data element 68 that includes entity types ET. An entity type et characterizes various aspects of the entity e, for example, a version of the software entity e. The ET may be formalized as ET={etᵢ|etᵢ is an entity type, 0<i≦l, where l is the number of different entity types for the cluster}. Furthermore, the structure 60 may include a service data element 70 that includes services S provided by the cluster. The services S may be formalized as S={sᵢ|sᵢ is a service instance to be provided by the cluster, 0<i≦m, where m is the number of different service instances to be provided by the cluster}. In the example shown in FIG. 3, services S_{A1} are provided by entities E_{A1}, services S_{A2} are provided by entities E_{A2}, services S_{B1}=S_{A1} are provided by entities E_{B1} and services S_{B2} are provided by entities E_{B2}.

In addition, the structure 60 may include an entity group data element 72, which includes entity groups EG. An entity group eg is a relation between some service instances of S provided and/or protected by some entities of E. Formally, the entity group is EG=S×E={egᵢ|egᵢ=(σ, ε), where σ is the set of service instances that are assigned to be provided and protected by the set of entities ε, σ ⊂ S and ε ⊂ E}. The use of Greek letters indicates a dual role of the element represented by the Greek letter, for example, σ is a subset of group S but at the same time a itself includes plural elements sᵢ. In one application, for any pair of sets of services σᵢ and σⱼ the following relation is satisfied σᵢ ∩ σⱼ=Ø, and a corresponding pair of sets of entities εᵢ and εⱼ satisfy εᵢ ∩ εⱼ=Ø. In other words, entities eᵢ that provide services sᵢ are not providing services sⱼ and also, entities eⱼ that are providing services sⱼ are not providing services sᵢ.

To further clarify the relation of the subsets (represented by Greek letters) to the corresponding sets (capital letters) and to single elements (small letters), assume, for exemplary purposes, that the set S of services for a given configuration is S={s₁, s₂, s₃}. Also, assume that the set E of entities that provide the services S is E={e₁, e₂, e₃, e₄, e₅}. Then, an entity group element may be eg₁=(σ₁, ε₁)=({s₁, s₂}, {e₁, e₂, e₃}) and another entity group element may be eg₂=(σ₂, ε₂)=({s₃}, {e₄, e₅}). Thus, each subset σ and ε includes plural services and entities respectively, and at the same time σ and ε are subsets of S and E, respectively. In addition, the subsets σ and ε are disjoint subsets as noted above.

Furthermore, depending on the redundancy model, an entity e may provide various services. For example, if there is a 2N redundancy, based on the above example, e₁ may provide both s₁ and s₂ services, e₂ may be standby for both s₁ and s₂ services, and e₃ is a spare. For a N+M (in this case 2+1) redundancy, e₁ may provide s₁, e₂ may provide s₂ and e₃ serves as a standby for both s₁ and s₂. In a case of N-way redundancy, e₁ may be active for s₁ and standby for s₂, e₂ can be active for s₂ and standby for s₁ and e₃ standby for both s₁ and s₂. In N-way-active redundancy all e₁, e₂, and e₃ may be actively serving both s₁ and s₂.

All these arrangements may be achieved with the same entities and services. Thus, according to an exemplary embodiment, a change in arrangements from a first configuration to a second configuration (for example, changing from N+M to N-way-active) has to be accounted by an upgrade campaign. The change in arrangements may require an upgrade even if there is no change in the entity type of the software itself.

At least some of the above introduced sets, i.e., the cluster C information, the entity types ET and the required services S are typically used as input for generating a configuration of the cluster. A new configuration may be automatically generated by a configuration module (not shown). The generated configuration may also contain the entities definition and the definition of their groupings, such that for each service definition, a redundant set of entities may be assigned to protect and provide the availability for the service. The redundant set of entities helps to maintain the availability of the services in case of failures, for example, or during an upgrade of the cluster.

However, according to an exemplary embodiment, the set of services that are provided with high availability in both the current configuration and the desired new configuration needs to be part of each of services S_{A1} and S_{B1} when considering the notations of FIG. 3. For example, if a set of entities ε_{A1} provides a service s1 in the current configuration, and s1 belongs to S_{A1}, to have the same service s1 provided in the new configuration, the service s1 needs to belong to set S_{B1} and to be part of the set of required services given as input for the new configuration generation. Thus, in the new configuration, a set of entities ε_{B1} that belong to set E_{B1} should be present for providing the same service s1. The requirement of service availability also dictates that group ε_{B1} needs to be the evolution of group ε_{A1}. Hence, ε_{A1} may become part of the upgrade target set and a procedure needs to be found to transform ε_{A1} into ε_{B1}.

By comparing the characteristics of ε_{A1} and ε_{B1} and their grouping an upgrade procedure (or a set of them) may be necessary. More specifically, if the characteristics of entities ε_{A1} and ε_{B1}, which are found in the corresponding single entity types et_{A} and et_{B}, are the same, no upgrade is necessary for ε_{A1} as ε_{A1} and ε_{B1} are identical. However, if the characteristics et_{A} and et_{B} or their grouping eg_{A} and eg_{B} are different for entities ε_{A1} and ε_{B1}, then an upgrade needs to be performed to transfer from ε_{A1} to ε_{B1} and/or from eg_{A} to eg_{B}. As an example, the characteristics et of entities ε may be a software version. One or more upgrade procedures may be selected to implement the above discussed transformation.

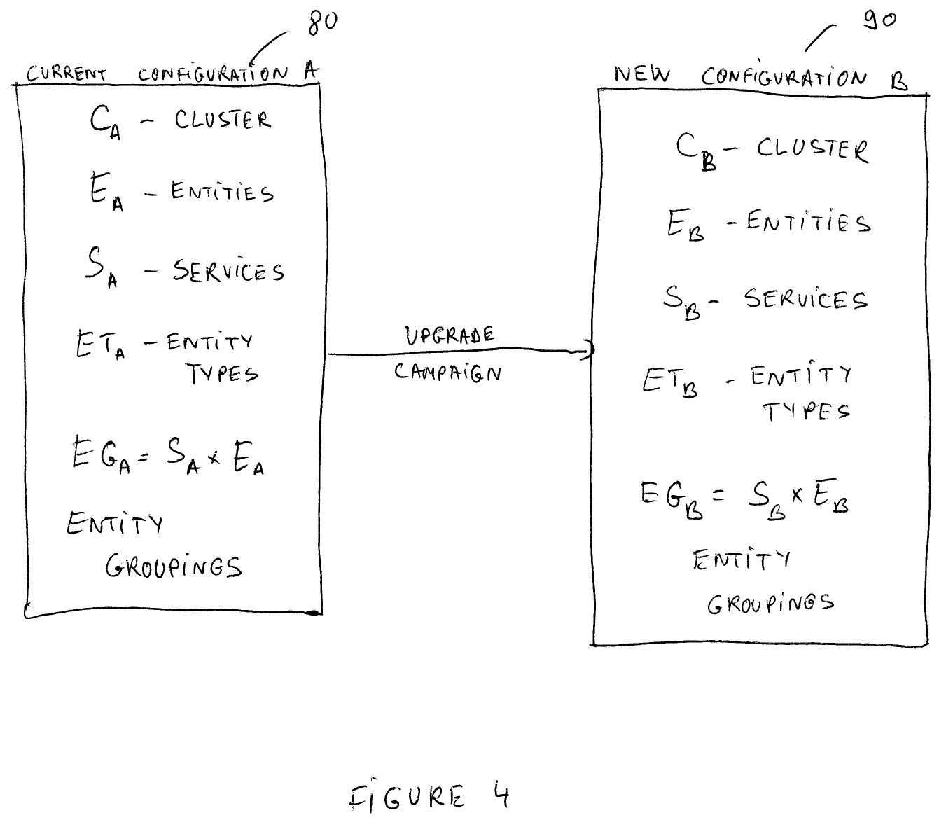

According to an exemplary embodiment illustrated in FIG. 4, a structure of a current configuration 80 of a cluster and a structure of a new configuration 90 of the cluster are shown. It is noted that for a general situation, S_{B}, E_{B}, ET_{B} and EG_{B} may be different from S_{A}, E_{A}, ET_{A} and EG_{A} but C_{A} may be identical to C_{B}. FIG. 4 does not show, contrary to FIG. 3, the entities E split as entities that are to be upgraded, entities to be removed and entities to be added. However, sets S_{A} and S_{B} may have a common subset AS (Available Services), i.e., AS=S_{A} ∩ S_{B}, where mathematical operation “∩” represents the intersection of two sets and is applicable only to sets of objects. According to an exemplary embodiment, sets S_{A} and S_{B} may be identical. Using the common subset AS, an entity group eg_{A} of the first configuration may be mapped to an entity group eg_{B} of the second configuration.

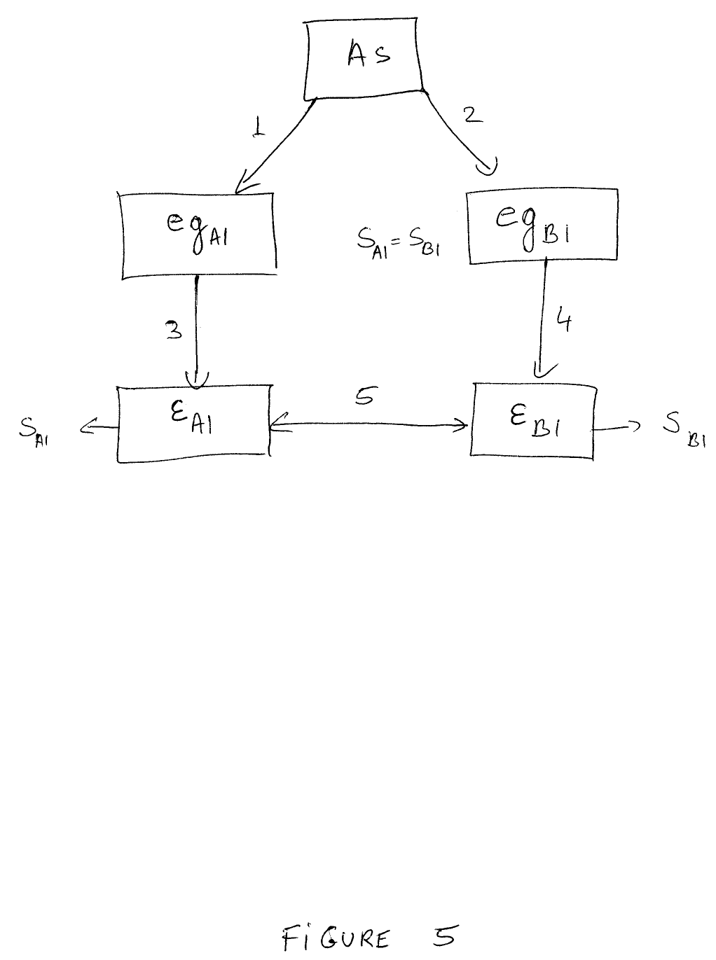

More specifically, according to an exemplary embodiment illustrated in FIG. 5, having determined the common subset AS of services, a service s_{A1} for the current configuration, which is identical to s_{B1} for the new configuration, is selected from AS. Based on the selected service s_{A1} or s_{B1}, a first corresponding entity group eg_{A1} for the first configuration and a second corresponding entity group eg_{B1} for the second configuration are determined in steps 1 and 2. The two entity groups eg_{A1} and eg_{B1} are determined as a pair as these entity groups should provide a same service in different configurations. The entity group eg_{A1} is an element of set EG_{A} and the entity group eg_{B1} is an element of set EG_{B}. Based on the subset AS and the entity groups eg_{A1} and eg_{B1}, a first subset of entities ε_{A1} and a second subset of entities ε_{B1} are identified in steps 3 and 4. The first subset ε_{A1} belongs to the set E_{A} and the second subset ε_{B1} belongs to the set E_{B}. Each of the subsets of entities ε_{A1} or ε_{B1} may include one or more entities e_{A} and e_{B}, respectively. In step 5, the first subset ε_{A1} is mapped to the second subset ε_{B1}. Thus, elements eg_{A1} ε EG_{A} of the current configuration are identified with elements eg_{B1} ε EG_{B} of the new configuration. That is, eg_{B1}=(σ_{B1}, ε_{B1}) is an upgrade of eg_{A1}=(σ_{A1}, ε_{A1}) if s ε AS and s ε σ_{B1} and s ε σ_{A1}, where s ε S. In other words, the upgrade campaign may need to include, if the groupings and/or the entity types are different between the current configuration and the desired new configuration, a procedure that transitions eg_{A1}→eg_{B1}, which means that the related entities need to be upgraded so that ε_{A1}→ε_{B1} and therefore, ε_{A1} becomes part of the upgrade target set.

Besides mapping the services from a first configuration to the services of a desired second configuration as discussed above, there may be services in the first configuration that should be terminated and there may be new services, not present in the first configuration, which should be added to arrive at the desired second configuration. In the following, the services that should be terminated are called TS (Terminated Services) and the new services that are added are called NS (New Services).

According to an exemplary embodiment, the subset TS is defined as TS=S_{A}\S_{B} and this subset includes the services that are to be discontinued when the upgrade from the first configuration to the second configuration is to be performed. The mathematical operation “\” is the subtraction of sets. Thus, associated entities in E_{A2} (see FIG. 3) that provide the services TS may be terminated and removed by the upgrade, i.e., any set of service instances σ_{A2} ⊂ TS are not provided in the new configuration and the associated set of entities ε_{A2} can be removed by the upgrade.

According to another exemplary embodiment, the subset NS=S_{B}\S_{A} includes the services that are newly added by the upgrade. Thus, the associated entities in E_{B2} are newly added to the new configuration, i.e., any set of service instances σ_{B2} ⊂ NS are added and the associated set of entities ε_{B2} is new and added by the upgrade.

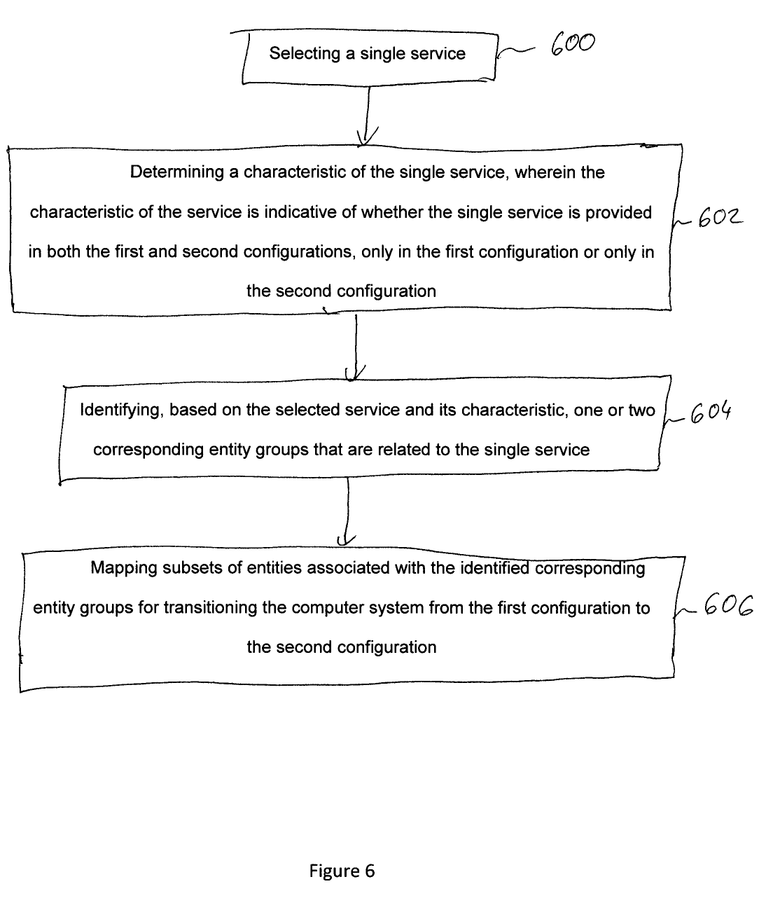

According to an exemplary embodiment illustrated in FIG. 6, various steps are shown of a method for identifying a target set of entities associated with a first configuration of a computer system that are to be modified for arriving at a second configuration of the computer system. The method includes a step 600 of selecting a single service, a step 602 of determining a characteristic of the single service, wherein the characteristic of the service is indicative of whether the single service is provided in both the first and second configurations, only in the first configuration or only in the second configuration, a step 604 of identifying, based on the selected service and its characteristic, one or two corresponding entity groups that are related to the single service, and a step 606 of mapping subsets of entities associated with the identified corresponding entity groups for transitioning the computer system from the first configuration to the second configuration.

According to another exemplary embodiment, the method illustrated in FIG. 6 may include the additional steps of determining that the characteristic is indicative of the selected service being provided in both the first and second configurations, the step of determining a first entity group (eg_{A}) for the first configuration and a second entity group (eg_{B}) for the second configuration such that the first entity group (eg_{A}) is associated with the single service (s) in the first configuration and the second entity group (eg_{B}) is associated with the single service (s) in the second configuration, the step of identifying a first corresponding subset of entities (ε_{A}) for the first configuration and a second corresponding subset of entities (ε_{B}) for the second configuration based on the single service (s), the first entity group (eg_{A}) and the second entity group (eg_{B}), wherein the single service (s) is an element of a subset of services (σ_{A}) associated with the first entity group (eg_{A}), and the step of mapping the first subset of entities (ε_{A}) to the second subset of entities (ε_{B}) if a corresponding entity type (et_{A}) of the first subset of entities (ε_{A}) is different from a corresponding entity type (et_{B}) of the second subset of entities (ε_{B}), wherein the corresponding entity types (et_{A} and et_{B}) describe at least one of a software version of an entity and a configuration of an entity group.

According to still another exemplary embodiment, the method illustrated in FIG. 6 may include the additional steps of determining that the characteristic is indicative of the selected service being provided only in the first configuration and not in the second configuration, the step of determining, based on the characteristic and the selected service, an entity group (eg_{A}) for the first configuration that is associated with the selected service (s) that is to be discontinued in the second configuration, and the step of identifying, based on the determined entity group (eg_{A}), a subset of entities (ε_{A}) to be removed after upgrading from the first configuration to the second configuration and which provides the single service (s).

According to another exemplary embodiment, the method illustrated in FIG. 6 may include the additional step of determining that the characteristic is indicative of the selected service to be provided only in the second configuration and not in the first configuration, the step of determining, based on the characteristic and the selected service, an entity group (eg_{B}) for the second configuration that is associated with the selected service (s) that is not provided by the first configuration, and a step of identifying, based on the determined entity group (eg_{B}), a subset of entities (ε_{B}) to be added in the second configuration for providing the single service (s).

Regarding this method, it is noted that the steps enumerated above contribute to transforming a machine (node or cluster) from one configuration to another configuration, thus effectively transforming the machine.

By introducing a naming schema (the formalism described in the previous exemplary embodiments), which reflects the services protected by an entity, the entity grouping can be made explicit in the configuration and the correlation of various configurations becomes manageable. The naming schema may be used when multiple configurations are generated for the same input set and the output sets are analyzed and compared in order to select a target configuration and potential migration path in terms of intermediate configurations.

Note that if ET_{A}≠ET_{B} and all configurations have been generated, then a smooth migration is occurring if there is a direct transition ε_{A}→ε_{B} for each (ε_{A}, ε_{B}) pairs, or if this is not possible, then an indirect migration path may be found such that ε_{A}→ε_{C} followed by ε_{C}→ε_{B}, where ε_{C} is part of one of the generated configurations other than the target configuration.

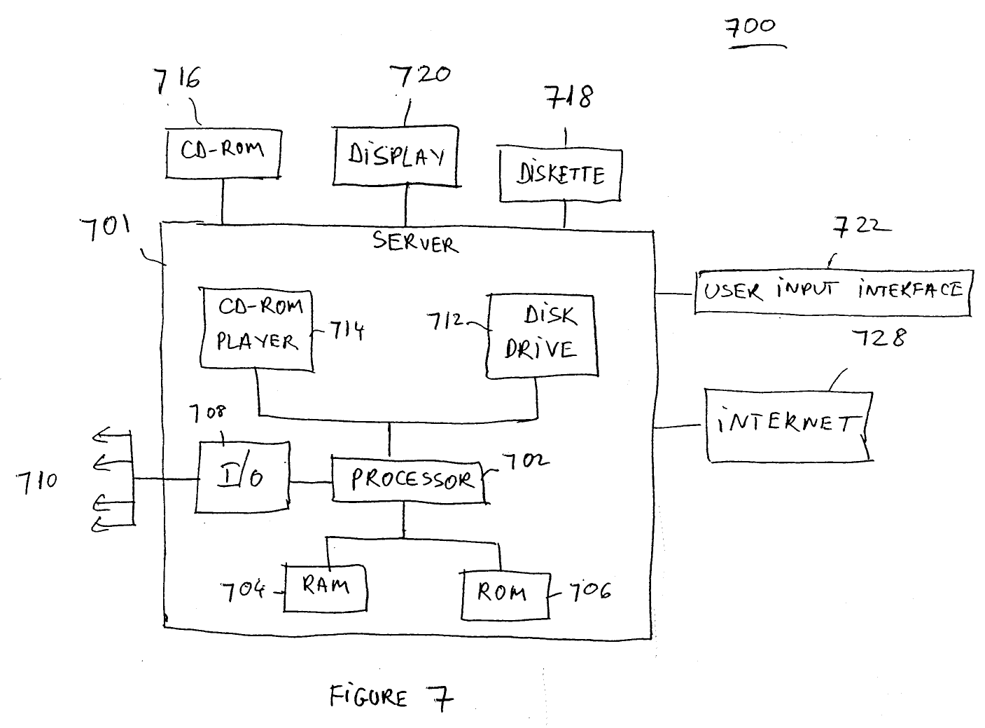

An example of a node of the HA system (computing arrangement) capable of carrying out operations in accordance with the exemplary embodiments is illustrated in FIG. 7.

The exemplary computing arrangement 700 suitable for performing the activities described in the exemplary embodiments may include server 701. Such a server 701 may include a central processor (CPU) 702 coupled to a random access memory (RAM) 704 and to a read-only memory (ROM) 706. The ROM 706 may also be other types of storage media to store programs, such as programmable ROM (PROM), erasable PROM (EPROM), etc. The processor 702 may communicate with other internal and external components through input/output (I/O) circuitry 708 and bussing 710, to provide control signals and the like. The processor 702 carries out a variety of functions as is known in the art, as dictated by software and/or firmware instructions.

The server 701 may also include one or more data storage devices, including hard and floppy disk drives 712, CD-ROM drives 714, and other hardware capable of reading and/or storing information such as DVD, etc. In one embodiment, software for carrying out the above discussed steps may be stored and distributed on a CD-ROM 716, diskette 718 or other form of media capable of portably storing information. These storage media may be inserted into, and read by, devices such as the CD-ROM drive 714, the disk drive 712, etc. The server 701 may be coupled to a display 720, which may be any type of known display or presentation screen, such as LCD displays, plasma display, cathode ray tubes (CRT), etc. A user input interface 722 is provided, including one or more user interface mechanisms such as a mouse, keyboard, microphone, touch pad, touch screen, voice-recognition system, etc.

The server 701 may be coupled to other computing devices, such as landline and/or wireless terminals via a network. The server may be part of a larger network configuration as in a global area network (GAN) such as the Internet 728, which allows ultimate connection to the various landline and/or mobile client devices.

The system 700 of FIG. 7 is provided as a representative example of a computing environment in which the principles of the present exemplary embodiments may be applied. From the description provided herein, those skilled in the art will appreciate that the present invention is equally applicable in a variety of other currently known and future mobile and fixed computing environments. It is noted that the principles of the present exemplary embodiments are equally applicable to other terminals, i.e., mobile computing systems.

The disclosed exemplary embodiments provide a computing system, a method and a computer program product for identifying a target set of entities associated with a first configuration of a computer system that are to be updated for arriving at a desired second configuration of the computer system. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

As also will be appreciated by one skilled in the art, the exemplary embodiments may be embodied in a personal computer, a mobile computing device, a cluster including various nodes, a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a specifically programmed computer or processor.

What is claimed is:

1. A method for identifying a target set of entities associated with a first configuration of a computer system that are to be modified for arriving at a second configuration of the computer system, the method comprising:
selecting a single service (s);
determining a characteristic of the single service (s), wherein the characteristic of the service is indicative of whether the single service is provided in both the first and second configurations, only in the first configuration or only in the second configuration;
identifying, based on the selected service and its characteristic, one or two corresponding entity groups (eg_{A} and/or eg_{B}) that are related to the single service (s); and
mapping subsets of entities (ε_{A} and/or ε_{B}) associated with the identified corresponding entity groups for transitioning the computer system from the first configuration to the second configuration.

2. The method of claim 1, further comprising:
determining that the characteristic is indicative of the selected service being provided in both the first and second configurations;
determining a first entity group (eg_{A}) for the first configuration and a second entity group (eg_{B}) for the second configuration such that the first entity group (eg_{A}) is associated with the single service (s) in the first configuration and the second entity group (eg_{B}) is associated with the single service (s) in the second configuration;
identifying a first corresponding subset of entities (ε_{A}) for the first configuration and a second corresponding subset of entities (ε_{B}) for the second configuration based on the single service (s), the first entity group (eg_{A}) and the second entity group (eg_{B}), wherein the single service (s) is an element of a subset of services (σ_{A}) associated with the first entity group (eg_{A}); and
mapping the first subset of entities (ε_{A}) to the second subset of entities (ε_{B}) if a corresponding entity type (et_{A}) of the first subset of entities (ε_{A}) is different from a corresponding entity type (et_{B}) of the second subset of entities (ε_{B}), wherein the corresponding entity types (et_{A} and et_{B}) describe at least one of a software version of an entity and a configuration of an entity group.

3. The method of claim 1, further comprising:
determining that the characteristic is indicative of the selected service being provided only in the first configuration and not in the second configuration;
determining, based on the characteristic and the selected service, an entity group (eg_{A}) for the first configuration that is associated with the selected service (s) that is to be discontinued in the second configuration; and
identifying, based on the determined entity group (eg_{A}), a subset of entities (ε_{A}) to be removed after upgrading from the first configuration to the second configuration and which provides the single service (s).

4. The method of claim 1, further comprising:
determining that the characteristic is indicative of the selected service to be provided only in the second configuration and not in the first configuration;
determining, based on the characteristic and the selected service, an entity group (eg_{B}) for the second configuration that is associated with the selected service (s) that is not provided by the first configuration; and
identifying, based on the determined entity group (eg_{B}), a subset of entities (ε_{B}) to be added in the second configuration for providing the single service (s).

5. The method of claim 1, wherein for pairs of subsets of entities (ε_{Ai}) and (ε_{Aj}) of a set of entities (E_{A}) and corresponding pairs of subsets of services (σ_{Ai}) and (σ_{Aj}) of a set of services (S_{A}) of the first configuration, (ε_{Ai}) intersected with (ε_{Aj}) is a null set, (σ_{Ai}) intersected with (σ_{Aj}) is a null set, (ε_{Ai}) is associated with service (σ_{Ai}) and (ε_{Aj}) is associated with services (σ_{Aj}).

6. The method of claim 1, wherein entity names of a first set of entity groups (EG_{A}) providing given services in the first configuration are different from entity names of a second set of entity groups (EG_{B}) providing the same given services in the second configuration.

7. The method of claim 1, wherein the second configuration is tailored for the computer system to take into consideration the entity types changes from the first configuration.

8. The method of claim 7, wherein the computer system includes one or more redundant nodes for providing high availability services.

9. A node configured to identify a target set of entities associated with a first configuration of a cluster that are to be modified for arriving at a second configuration of the cluster, the node comprising:
a processor configured to
select a single service (s);
determine a characteristic of the single service (s), wherein the characteristic of the service is indicative of whether the single service is provided in both the first and second configurations, only in the first configuration or only in the second configuration;
identify, based on the selected service and its characteristic, one or two corresponding entity groups (eg_{A} and/or eg_{B}) that are related to the single service (s); and
map subsets of entities (ε_{A} and/or ε_{B}) associated with the identified corresponding entity groups for transitioning the computer system from the first configuration to the second configuration.

10. The node of claim 9, wherein the processor is further configured to:
determine that the characteristic is indicative of the selected service being provided in both the first and second configurations;
determine a first entity group (eg_{A}) for the first configuration and a second entity group (eg_{B}) for the second configuration such that the first entity group (eg_{A}) is associated with the single service (s) in the first configuration and the second entity group (eg_{B}) is associated with the single service (s) in the second configuration;
identify a first corresponding subset of entities (ε_{A}) for the first configuration and a second corresponding subset of entities (ε_{B}) for the second configuration based on the single service (s), the first entity group (eg_{A}) and the second entity group (eg_{B}), wherein the single service (s) is an element of a subset of services (σ_{A}) associated with the first entity group (eg_{A}); and
map the first subset of entities (ε_{A}) to the second subset of entities (ε_{B}) if a corresponding entity type (et_{A}) of the first subset of entities (ε_{A}) is different from a corresponding entity type (et_{B}) of the second subset of entities (ε_{B}), wherein the corresponding entity types (et_{A} and et_{B}) describe at least one of a software version of an entity and a configuration of an entity group.

11. The node of claim 9, wherein the processor is further configured to:
determine that the characteristic is indicative of the selected service being provided only in the first configuration and not in the second configuration;
determine, based on the characteristic and the selected service, an entity group (eg_{A}) for the first configuration that is associated with the selected service (s) that is to be discontinued in the second configuration; and
identify, based on the determined entity group (eg_{A}), a subset of entities (ε_{A}) to be removed after upgrading from the first configuration to the second configuration and which provides the single service (s).

12. The node of claim 9, wherein the processor is further configured to:
determine that the characteristic is indicative of the selected service to be provided only in the second configuration and not in the first configuration;
determine, based on the characteristic and the selected service, an entity group (eg_{B}) for the second configuration that is associated with the selected service (s) that is not provided by the first configuration; and
identify, based on the determined entity group (eg_{B}), a subset of entities (ε_{B}) to be added in the second configuration for providing the single service (s).

13. A computer readable medium including computer executable instructions, wherein the instructions, when executed, implement a method for identifying a target set of entities associated with a first configuration of a computer system that are to be modified for arriving at a second configuration of the computer system, the method comprising:
selecting a single service (s);
determining a characteristic of the single service (s), wherein the characteristic of the service is indicative of whether the single service is provided in both the first and second configurations, only in the first configuration or only in the second configuration;
identifying, based on the selected service and its characteristic, one or two corresponding entity groups (eg_{A} and/or eg_{B}) that are related to the single service (s); and
mapping subsets of entities (ε_{A} and/or ε_{B}) associated with the identified corresponding entity groups for transitioning the computer system from the first configuration to the second configuration.

14. The medium of claim 13, further comprising:
determining that the characteristic is indicative of the selected service being provided in both the first and second configurations;
determining a first entity group (eg_{A}) for the first configuration and a second entity group (eg_{B}) for the second configuration such that the first entity group (eg_{A}) is associated with the single service (s) in the first configuration and the second entity group (eg_{B}) is associated with the single service (s) in the second configuration;
identifying a first corresponding subset of entities (ε_{A}) for the first configuration and a second corresponding subset of entities (ε_{B}) for the second configuration based on the single service (s), the first entity group (eg_{A}) and the second entity group (eg_{B}), wherein the single service (s) is an element of a subset of services (σ_{A}) associated with the first entity group (eg_{A}); and
mapping the first subset of entities (ε_{A}) to the second subset of entities (ε_{B}) if a corresponding entity type (et_{A}) of the first subset of entities (ε_{A}) is different from a corresponding entity type (et_{B}) of the second subset of entities (ε_{B}), wherein the corresponding entity types (et_{A} and et_{B}) describe at least one of a software version of an entity and a configuration of an entity group.

15. The medium of claim 13, further comprising:
determining that the characteristic is indicative of the selected service being provided only in the first configuration and not in the second configuration;
determining, based on the characteristic and the selected service, an entity group (eg_{A}) for the first configuration that is associated with the selected service (s) that is to be discontinued in the second configuration; and
identifying, based on the determined entity group (eg_{A}), a subset of entities (ε_{A}) to be removed after upgrading from the first configuration to the second configuration and which provides the single service (s).

16. The medium of claim 13, further comprising:
determining that the characteristic is indicative of the selected service to be provided only in the second configuration and not in the first configuration;
determining, based on the characteristic and the selected service, an entity group (eg_{B}) for the second configuration that is associated with the selected service (s) that is not provided by the first configuration; and
identifying, based on the determined entity group (eg_{B}), a subset of entities (ε_{B}) to be added in the second configuration for providing the single service (s).

17. The medium of claim 13, wherein for pairs of subsets of entities (ε_{Ai}) and (ε_{Aj}) of a set of entities (E_{A}) and corresponding pairs of subsets of services (σ_{Ai}) and (σ_{Aj}) of a set of services (S_{A}) of the first configuration, (ε_{Ai}) intersected with (ε_{Aj}) is a null set, (σ_{Ai}) intersected with (σ_{Aj}) is a null set, (ε_{Ai}) is associated with service (σ_{Ai}) and (ε_{Aj}) is associated with services (σ_{Aj}).

18. The medium of claim 13, wherein entity names of a first set of entity groups (EG_{A}) providing given services in the first configuration are different from entity names of a second set of entity groups (EG_{B}) providing the same given services in the second configuration.

19. The medium of claim 13, wherein the second configuration is tailored for the computer system to take into consideration the entity types changes from the first configuration.

20. The medium of claim 19, wherein the computer system includes one or more redundant nodes for providing high availability services.
